(19) United States
(12) Patent Application Publication
(10) Pub. No.: US 2024/0214059 A1
(43) Pub. Date: Jun. 27, 2024

(54) ELECTRONIC DEVICE IN HIGH-ALTITUDE PLATFORM STATION-TERRESTRIAL COMMUNICATION SYSTEM

(71) Applicant: NTT DOCOMO, INC., Tokyo (JP)

(72) Inventors: Wenjia Liu, Beijing (CN); Jing Wang, Beijing (CN); Weiqi Sun, Beijing (CN); Xiaolin Hou, Beijing (CN); Lan Chen, Beijing (CN); Yuki Hokazono, Tokyo (JP)

(73) Assignee: NTT DOCOMO, INC., Tokyo (JP)

(21) Appl. No.: 18/556,555

(22) PCT Filed: May 10, 2021
(86) PCT No.: PCT/CN2021/092891

§ 371 Date: Oct. 20, 2023

(51) Int. Cl. H04B 7/185; H04W 24/02

(52) U.S. Cl. CPC H04B 7/18504; H04W 24/02

(57) ABSTRACT

The present disclosure provides an electronic device in a high-altitude platform station-terrestrial communication system, including: a receiving unit configured to obtain traffic load information of a cell in the communication system; a control unit configured to determine configuration information of at least one of a high-altitude platform station (HAPS) and a terrestrial base station covering the cell according to the traffic load information; and a transmitting unit configured to notify of the configuration information.

### TECHNICAL FIELD

The present disclosure relates to a field of wireless communication, and more particularly to an electronic device in a communication network jointly designed by a High-Altitude Platform Station (HAPS) and a terrestrial cellular network.

### BACKGROUND

In future communication systems, a spatial stereo technique is proposed. In this spatial stereo technique, high, medium and low orbit satellites and a High-Altitude Platform Station (HAPS) may be used to communicate with a terrestrial cellular network to provide services for terrestrial users.

Specifically, a high-altitude platform station (HAPS) is typically provided at a height of around 20 kilometers from the ground to provide communication services for terrestrial users. The HAPS may communicate with a Customer Premises Equipment (CPE) located on the ground, which in turn serves the terrestrial users. Alternatively, the HAPS provides access links directly to the users, thereby communicating directly with the terrestrial users.

However, since an area covered by the HAPS may be adjacent to, or at least partially overlap, an area covered by the existing terrestrial communication system, the HAPS may cause co-frequency or pro-frequency interference to the existing terrestrial communication system after deployment.

To reduce frequency interference, a method of Inter Cell Interference Coordination (ICIC) is proposed. In particular, different frequency bands are used for different areas covered by the HAPS and the terrestrial system, or for areas covered by the HAPS and the terrestrial system in overlap. Interference between the two systems is addressed by orthogonalizing the space or frequency resources used by the HAPS and the terrestrial system. However, the ICIC approach solves the interference problem simply by resource orthogonalization without a more detailed analysis of the interference to better coordinate the two systems.

### SUMMARY

According to an aspect of the present disclosure, an electronic device in a high-altitude platform station-terrestrial communication system is provided. The electronic device comprises: a receiving unit configured to obtain traffic load information of a cell in the communication system; a control unit configured to determine configuration information of at least one of a high-altitude platform station (HAPS) and a terrestrial base station covering the cell based on the traffic load information; and a transmitting unit configured to notify of the configuration information.

According to another aspect of the present disclosure, the control unit of the electronic device is further configured to determine coverage information of cells in the high-altitude platform station-terrestrial communication system, wherein the coverage information of each cell indicates that the cell is covered by one or both of the HAPS and the terrestrial base station.

According to another aspect of the present disclosure, the receiving unit is further configured to obtain channel state information of the cell in the communication system; and the control unit is further configured to determine the configuration information of at least one of the HAPS and the terrestrial base station covering the cell according to the channel state information.

According to another aspect of the present disclosure, the HAPS in the high-altitude platform station-terrestrial is connected to a cloud; the terrestrial base station in the high-altitude platform station-terrestrial is connected to the cloud; the electronic device is disposed in the cloud; the receiving unit receives traffic load information from cells of the HAPS and the terrestrial base station in the high-altitude platform station-terrestrial; and the transmitting unit notifying at least one of the HAPS and the terrestrial base station in the high-altitude platform station-terrestrial of the configuration information.

According to another aspect of the present disclosure, the electronic device is the HAPS in the high-altitude platform station-terrestrial; the receiving unit obtains traffic load information of a cell covered by the HAPS and receives, from the a terrestrial base station within the coverage range of the HAPS, traffic load information of a cell covered by the terrestrial base station; and the transmitting unit notifies at least one of the HAPS and the terrestrial base station within the coverage range of the HAPS of the configuration information. Alternatively, the electronic device is the terrestrial base station; the receiving unit obtains traffic load information of a cell covered by the terrestrial base station and receives, from an HAPS corresponding to the terrestrial base station, traffic load information of a cell covered by the HAPS; and the transmitting unit notifies at least one of the terrestrial base station and the HAPS corresponding to the terrestrial base station of the configuration information. Optionally, the HAPS and the terrestrial base station communicate over an interface between base stations or a backhaul interface. Furthermore, optionally, the HAPS is used as a centralized unit or a donor-distributed unit of integrated access backhaul, and a customer premises equipment (CPE) connected to the HAPS is used as a distribution unit of the integrated access backhaul or a mobile terminal.

According to another aspect of the present disclosure, the electronic device is a customer premises equipment (CPE) connected to the HAPS in the high-altitude platform station-terrestrial; the receiving unit obtains traffic load information on at least one of a cell covered by the HAPS to which the CPE is connected and a cell covered by the CPE, and receives, from a terrestrial base station within a coverage range of the CPE, traffic load information of a cell covered by the terrestrial base station; and the transmitting unit notifies at least one of the CPE and the terrestrial base station within the coverage range of the CPE of the configuration information. Alternatively, the electronic device is the terrestrial base station; the receiving unit obtains traffic load information of a cell covered by the terrestrial base station and receives, from a customer premises equipment (CPE) corresponding to the terrestrial base station, traffic load information of a cell covered by the CPE; and the transmitting unit notifies at least one of the CPE corresponding to the terrestrial base station and the terrestrial base station of the configuration information. Furthermore, optionally, the CPE and the terrestrial base station communicate over an interface between base stations or a backhaul interface.

According to another aspect of the present disclosure, an information transmission method is provided. The information transmission method includes obtaining traffic load information of a cell in a high-altitude platform station-terrestrial communication system; determining configuration information of at least one of a high-altitude platform station (HAPS) and a terrestrial base station covering the cell according to the traffic load information; and notifying of the configuration information.

In examples according to the present disclosure, by comprehensively considering traffic loads of cells covered by an HAPS and a terrestrial base station (BS) in a high-altitude platform station-terrestrial communication system, the HAPS and the terrestrial BS may be uniformly coordinated and configured, thereby improving the performance of the communication system.

### BRIEF DESCRIPTION OF DRAWINGS

The above and other objects, features and advantages of the present disclosure will become more obvious by describing embodiments of the present disclosure in more detail in conjunction with accompanying drawings. The accompanying drawings are provided to provide a further understanding of the embodiments of the present disclosure, constitute a part of the specification, serve to explain the present disclosure together with the embodiments of the present disclosure, and do not constitute a limitation of the present disclosure. In the drawings, like reference numerals usually represent like components or steps.

FIG. 1 shows a schematic diagram of a wireless communication system in which the embodiments of the present disclosure may be applied.

FIG. 2 is a schematic block diagram illustrating an electronic device according to an embodiment of the present disclosure.

FIGS. 3A and 3B are schematic diagrams showing an example case where the electric device shown in FIG. 2 is applied to the communication system shown in FIG. 1.

FIG. 4 is a schematic diagram illustrating an HAPS and a terrestrial base station connected to the cloud, according to an embodiment of the present disclosure.

FIG. 5 is a schematic diagram illustrating an example case where the electronic device is an HAPS.

FIG. 6 is a schematic diagram illustrating an example case where the electronic device is a CPE.

FIG. 7 is a flowchart of an information transmission method according to an embodiment of the present disclosure.

FIG. 8 is a schematic diagram of a hardware structure of an involved device according to an embodiment of the present disclosure.

### DETAILED DESCRIPTION

In order to make the objects, technical solutions and advantages of the present disclosure more obvious, exemplary embodiments according to the present disclosure will be described in detail below with reference to the accompanying drawings. Like reference numerals refer to like elements throughout the drawings. It should be appreciated that the embodiments described herein are merely illustrative and should not be construed as limiting the scope of the present disclosure.

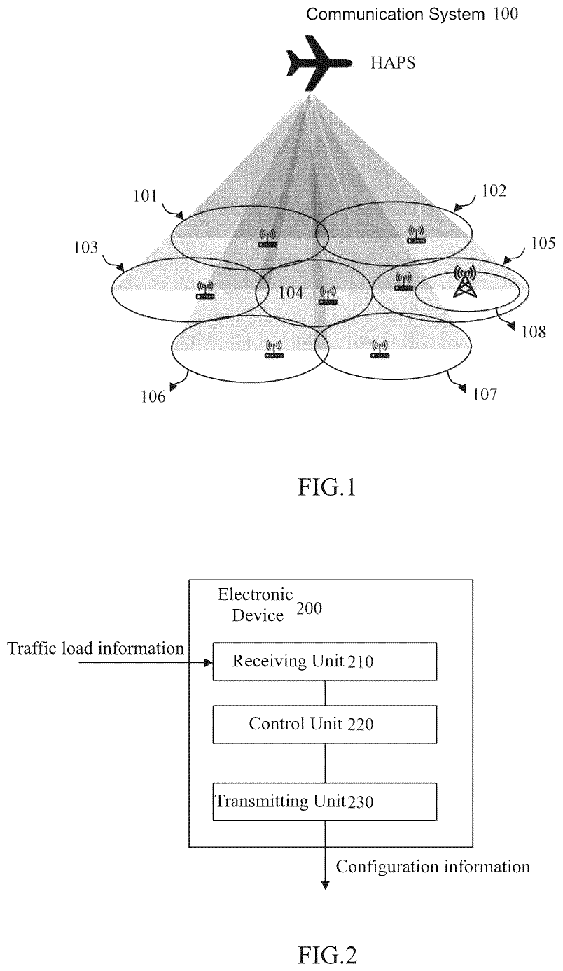

First, a high-altitude platform station-terrestrial communication system to which embodiments of the present disclosure may be applied will be described with reference to FIG. 1. FIG. 1 shows a schematic diagram of a high-altitude platform station-terrestrial communication system 100 in which the embodiments of the present disclosure may be applied. A terrestrial portion in the communication system 100 shown in FIG. 1 may be a 5G communication network already deployed on the ground, or may be any other type of terrestrial wireless communication network, such as a 4G or 6G communication network, or the like. The embodiments of the present disclosure will be described below with a 5G communication network as an example, but it should be appreciated that the following description may also be applicable to other types of wireless communication networks.

The communication system 100 may include a base station (hereinafter simply referred to as a “terrestrial base station”) in a 5G communication network, a CPE disposed on the ground and may communicable with an HAPS, and an HAPS. As shown in FIG. 1, each terrestrial base station in the communication system 100 covers one cell. The HAPS may perform multi-beam transmission, where each beam covers one CPE, and each CPE covers one cell. In FIG. 1, cells 101-107 are cells covered by CPEs connected with HAPS respectively, and cell 108 is a cell covered by a terrestrial base station. In the example shown in FIG. 1, description is made by taking the example where the cell 108 covered by the terrestrial base station is located in the cell 105 covered by a CPE. Alternatively, areas covered by the terrestrial base station and the CPE may also be adjacent or only partially overlapped. Furthermore, in the example shown in FIG. 1, description is made by taking the example where the HAPS provides service to users via a CPE. However, it should be understood that the scheme in the present disclosure is also applicable to the case where the HAPS provides an access link directly to the users, thereby communicating directly with terrestrial users.

As described above, according to the presently proposed inter-cell interference coordination method, interference caused by the HAPS to the terrestrial system can be reduced by using different frequency bands for different areas covered by the HAPS and the terrestrial system, or for areas covered by the HAPS and the terrestrial system in overlap. The method solves the interference problem simply by resource orthogonalization without a more detailed analysis of the interference to better coordinate the two systems. According to the embodiments of the present disclosure, it is desirable to achieve uniform coordination and configuration for the HAPS and the terrestrial base station (BS) for better system performance, by comprehensively considering traffic loads of cells covered by the HAPS and the terrestrial BS in the high-altitude platform station-terrestrial communication system.

Hereinafter, an electronic device according to an embodiment of the present disclosure is illustrated with reference to FIG. 2. FIG. 2 is a schematic block diagram illustrating an electronic device according to an embodiment of the present disclosure. As shown in FIG. 2, an electronic device 200 according to an embodiment of the present disclosure may include a receiving unit 210, a control unit 220, and a transmitting unit 230. The electronic device 200 may further include other components in addition to the receiving unit, the control unit, and the transmitting unit, however, since these components are not relevant to the contents of the embodiments of the present disclosure, illustration and description thereof are omitted herein. Furthermore, in the embodiment according to the present disclosure, when the high-altitude platform station (HAPS) directly provides service for terrestrial users, information about the HAPS (e.g., configuration information, channel state information, etc.) may be information about the HAPS itself. When the high-altitude platform station (HAPS) is connected to a CPE and services the terrestrial users via the CPE, the information about the HAPS may include both information about the HAPS itself and information about the CPE connected to the HAPS.

As shown in FIG. 2, the receiving unit 210 of the electronic device 200 may obtain traffic load information of a cell in the communication system. According to an example of the present disclosure, the traffic load information may indicate one or more of a number of activated terminals in the cell, a throughput requirement of the cell, or a buffer status. Furthermore, according to another example of the present disclosure, the receiving unit 210 may dynamically or semi-statically obtain the traffic load information of the cell in the communication system as needed. For example, the traffic load information may be traffic load information at the current time. As another example, the traffic load information may be statistical information for a predetermined period of time in the past. In addition, the traffic load information may also indicate a predicted traffic load for a predetermined period of time in the future.

For example, in the case where the cell in the communication system is covered by a terrestrial base station, the receiving unit 210 may receive the traffic load information of the cell from the terrestrial base station. In the case where the cell in the communication system is covered by an HAPS or a CPE connected to the HAPS, the receiving unit 210 may receive the traffic load information of the cell from the HAPS or the CPE connected to the HAPS. As another example, in the case where the cell in the communication system is covered by both an HAPS and a terrestrial base station, the receiving unit 210 may receive the traffic load information of the cell from both the terrestrial base station and the HAPS (or a CPE connected to the HAPS).

The control unit 220 may determine configuration information of at least one of a high-altitude platform station (HAPS) and a terrestrial base station covering the cell based on the traffic load information. Then, the transmitting unit 230 notifies a corresponding device of the configuration information determined by the control unit 220.

According to an example of the present disclosure, the configuration information may indicate an operating state of the device. For example, the operating state of the terrestrial base station may include an active state, an idle state, and the like. The configuration information of the HAPS may include information such as beams, time-frequency resources, and the like used when the HAPS is used for transmission to a specific cell. In addition, in the case where the HAPS provides services to users via a CPE, the configuration information of the HAPS may also indicate an operating state of the CPE connected to the HAPS. For example, the operating state of the CPE may include an on state or a non-on state. The on state may refer to a state in which the CPE is functioning normally to provide service to the users. The non-on state may refer to a state in which the CPE has some functions turned off to reduce interference and conserve power consumption, where the non-on state may be further divided into a full dormant state, a semi-dormant state, an idle state, etc., depending on how many functions need to be turned off. Similar to the CPE, the operating state of the terrestrial base station may include an on state or a non-on state, or the like. Furthermore, the configuration information may be configuration information on one or more bands.

According to another example of the present disclosure, the electronic device 200 may obtain deployment information of the high-altitude platform station-terrestrial communication system, and the control unit 220 may determine the configuration information of at least one of the high-altitude platform station (HAPS) and the terrestrial base station in combination with the received traffic load information and the deployment information. For example, the deployment information may include coverage information indicating the presence of one or both of an HAPS (or a CPE connected to the HAPS) and a terrestrial base station within the range of the cell. In this case, the control unit 220 may also determine coverage information of the cell in the high-altitude platform station-terrestrial communication system; and further determine the configuration information of at least one of the high-altitude platform station (HAPS) and the terrestrial base station covering the cell based on the coverage information. For example, for a cell indicated by the coverage information as covered by one of the HAPS and the terrestrial base station, the control unit 220 may determine that service is provided by an apparatus of the HAPS and the terrestrial base station covering the area. In addition, the control unit 220 may further determine to temporarily not provide service to the area based on the traffic load information of the area. For a cell indicated by the coverage information as covered in overlap by the HAPS and the terrestrial base station, the control unit 220 may determine that the area is served by one or both of the HAPS and the terrestrial base station based on the traffic load information of the area, or that neither the HAPS nor the terrestrial base station temporarily serves the area based on the traffic load information of the area.

A cell being covered by one of the HAPS and the terrestrial base station may refer to that the entire area or an area satisfying a predetermined condition (e.g., an area reaching a predetermined area) of the cell is covered by one of the HAPS and the terrestrial base station. Furthermore, a cell being covered by both the HAPS and the terrestrial base station may refer to that the entire area or an area satisfying a predetermined condition (e.g., an area reaching a predetermined area) of the cell is covered by both the HAPS and the terrestrial base station.

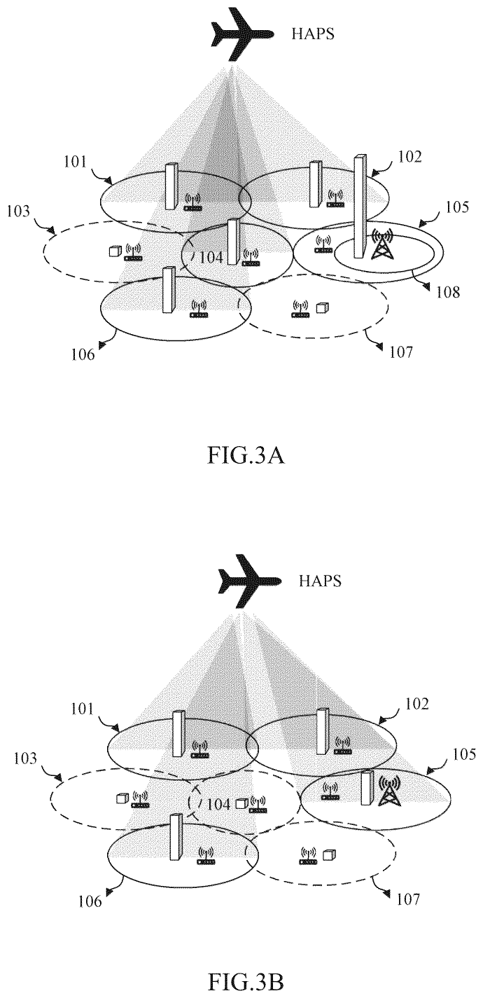

FIGS. 3A and 3B are schematic diagrams of one example case where the electric device shown in FIG. 2 is applied to the communication system 100 shown in FIG. 1. In the examples shown in FIGS. 3A and 3B, the column in each cell indicate a traffic load of that cell. In FIG. 3A, the receiving unit 210 may obtain traffic load information indicating that traffic loads of the cells 101, 102, 104, 106 are medium, traffic loads of the cells 108 and 105 are high, and traffic loads of the cells 103, 107 are low.

The control unit 220 may determine, based on the traffic load information of the cells 108 and 105, that both the terrestrial base stations and CPE corresponding to the cells 108 and 105 should be in an active state to serve the areas, and that the HAPS uses time-frequency resources for the CPE corresponding to the cell 105 that are orthogonal to time-frequency resources used by the terrestrial base station in the cell 108 to avoid interference. Furthermore, since the cells 101, 102, 104, 106 are served only by CPEs and the HAPS, traffic loads thereof are medium and served only by the CPEs connected to the HAPS, the control unit 220 may determine that the CPEs corresponding to the cells 101, 102, 104, 106 each should be in an active state to serve the areas, and that the HAPS turns on beams for the cells 101, 102, 104, 106. Furthermore, since the traffic loads of the cells 103, 107 are low, the control unit 220 may determine that CPEs to which the cells 103, 107 correspond should be in a dormant state for a certain period of time to save power consumption, and determine that the HAPS turns off beams for the cells 103, 107. The transmitting unit 230 may notify the terrestrial base station, the CPE, and the HAPS of the corresponding configuration information.

In FIG. 3B, the receiving unit 210 may obtain traffic load information indicating that traffic loads of the cells 101, 102, 105 (including the cells 108 located therein), 106 are medium, and traffic loads of the cells 103, 104, 107 are low. The control unit 220 may determine from the traffic load information of the cell 105 (including the cell 108 located therein) that the terrestrial base station may be in an idle state, and the area is served only by the CPE and the HAPS. Furthermore, since the cells 101, 102, and 106 are served only by the CPE and HAPS and traffic loads thereof are medium, the control unit 220 may determine that CPEs corresponding to the cells 101, 102, 106 each should each be in an active state to serve the areas, and that the HAPS turns on beams for the cells 101, 102, 106. Furthermore, since traffic loads of the cells 103, 104, 107 are low, the control unit 220 may determine that CPEs to which the cells 103, 104, 107 correspond should be in a dormant state for a certain period of time to save power consumption, and determine that the HAPS turns off beams for the cells 103, 104, 107. The transmitting unit 230 may notify the terrestrial base station, the CPE, and the HAPS of the corresponding configuration information.

In the example shown in FIG. 3, description has been made by taking the example that the cell 108 covered by the terrestrial base station is located within the cell 105 covered by the CPE, that is, the area of the cell 108 covered by the terrestrial base station is smaller than the area of the cell 105 covered by the CPE. Alternatively, where the area of the cell covered by the terrestrial base station is the same as or approximate to the corresponding area of the cell covered by the CPE, and when the traffic load information of the cell 108 covered by the terrestrial base station indicates that the traffic load of the cell is high, the control unit 220 may determine from the traffic load information of the cell 108 that the CPE serving the area enters an idle state and turns off beams in the HAPS for the area, and the area is served by the terrestrial base station, thereby avoiding interference between the HAPS and the terrestrial base station. The transmitting unit 230 may notify the terrestrial base station of configuration information indicating an active state, the CPE of configuration information indicating an idle state, and the HAPS of configuration information to turn off beams for the area.

Furthermore, according to another example of the present disclosure, the receiving unit 210 may further obtain channel state information of the cell in the communication system, and the control unit 220 may further determine the configuration information of at least one of the HAPS and the terrestrial base station covering the cell according to the channel state information. For example, for a cell covered by a CPE, the channel state information of the cell may be channel state information between the CPE to which the cell corresponds and a terminal device connected to the CPE. In addition, the channel state information may also include channel state information between a corresponding HAPS beam of the cell and the CPE covering the cell.

For a cell covered by the terrestrial base station, the channel state information of the cell may be channel state information between the terrestrial base station to which the cell corresponds and a terminal device connected to the terrestrial base station.

In the electronic device according to an embodiment of the present disclosure, the control unit 220 may determine configuration information of at least one of the high-altitude platform station (HAPS) and the terrestrial base station in the communication system according to traffic load information of the cell, so as to improve at least one of spectral efficiency (SE) and energy efficiency (EE) of the HAPS terrestrial system. By comprehensively considering traffic load of cells covered by the HAPS and the terrestrial base stations in the high-altitude platform station-terrestrial communication system, uniform coordination and configuration of the HAPS and the terrestrial base stations is achieved, resulting in better system performance.

In examples according to the present disclosure, the electronic device 200 may be disposed in a cloud, or the HAPS, a CPE connected to the HAPS, or the terrestrial base station may be used as the electronic device 200, depending on different needs.

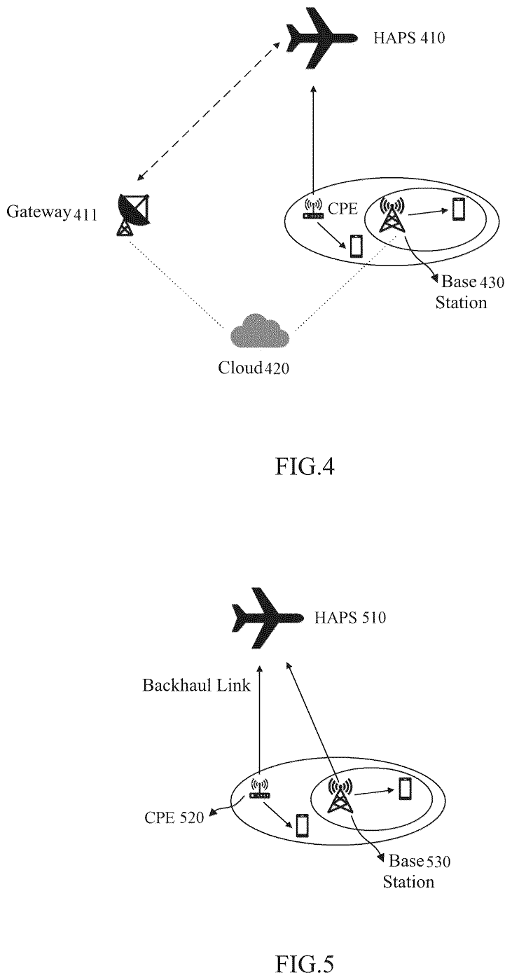

FIG. 4 is a schematic diagram illustrating the HAPS and the terrestrial base station connected to the cloud, according to an embodiment of the present disclosure. As shown in FIG. 4, the HAPS 410 is connected to the cloud (e.g., the Internet) 420 via a gateway 411, and the terrestrial base station 430 is connected to the cloud 420 via a core network (not shown).

In the example shown in FIG. 4, the electronic device 200 described above in connection with FIG. 2 may be disposed in the cloud 420. The receiving unit 210 of the electronic device 200 may receive traffic load information of a cell from the HAPS 410 and the terrestrial base station 430, and the transmitting unit 230 may notify at least one of the HAPS 410 and the terrestrial base station 430 of the configuration information. As shown in FIG. 4, the receiving unit 210 may receive information from the HAPS 410 via the gateway 411 and information from the base station 430 via the core network. Accordingly, the transmitting unit may transmit information to the HAPS 410 via the gateway 411 and to the base station 430 via the core network.

Furthermore, in the case where the HAPS provides service to the terrestrial users via CPE as shown in FIG. 4, the HAPS may interact with the CPE using a backhaul link between the HAPS and the CPE that has been proposed so far.

In the example shown in FIG. 4, although described using one HAPS as an example, it should be understood that the electronic device 200 located in the cloud may obtain information of each of HAPSs and terrestrial base stations in the high-altitude platform station-terrestrial communication system, and configure it. Thus, by placing the electronic device 200 in the cloud, it is possible to perform global optimization based on information of all cells in the HAPS terrestrial system to provide the best performance. However, this also results in a large amount of information that needs to be exchanged and a complex optimization algorithm.

Alternatively, according to another embodiment of the present disclosure, the electronic device 200 may be one of an HAPS and a terrestrial base station, so that in this embodiment, it is sufficient to perform information interaction between the HAPS and a cell covered by the HAPS and a terrestrial base station within the range of the cell covered by the HAPS. For example, the electronic device 200 may be an HAPS. In this case, the receiving unit 210 may obtain traffic load information of a cell covered by the HAPS and receive traffic load information of the cell covered by the terrestrial base station from the terrestrial base station. The transmitting unit 230 may notify at least one of the HAPS and the terrestrial base station of the configuration information.

FIG. 5 is a schematic diagram illustrating an example case where the electronic device 200 is an HAPS. As shown in FIG. 5, where HAPS 510 communicates with users via a terrestrial CPE 520, the receiving unit and the transmitting unit of the electronic device 200 (i.e., the HAPS 510) may interact with the CPE using the backhaul link between the HAPS and the CPE that has been proposed so far. In addition, the HAPS may be taken as a parent node and the CPE connected to the HAPS may be taken as a child node according to an integrated access backhaul (IAB) mechanism. For example, the HAPS may be used as a centralized unit (CU) or a donor-distributed unit (donor-DU) of an integrated access backhaul (IAB), and the CPE connected to the HAPS may be used as a distributed unit (DU) or a mobile terminal. Thus, an interface between the CU and the DU or between the donor-DU and the MT in the IAB may be used for information interaction between the HAPS and the CPE.

In addition, since there is currently no communication interface between the HAPS and the terrestrial base station, a communication interface between the HAPS and the terrestrial base station may be provided for information interaction. According to an example of the present disclosure, the HAPS may be taken as one base station, so that information interaction between the HAPS and the terrestrial base station may be performed using an interface between the base station and the base station. For example, the information interaction between the HAPS and the terrestrial base station may be performed using the X2 interface in the LTE system, or the Xn interface in the 5G NR system. According to another example of the present disclosure, the terrestrial base station may be considered as one child node of the HAPS, so that information interaction between the HAPS and the terrestrial base station may be performed using a backhaul interface. It should be noted that since the altitude of the HAPS is high, transmission and reception angles of the terrestrial base station may be adjusted according to the altitude of the HAPS in the case of information interaction between the HAPS and the terrestrial base station is performed using the interface between the base station and the base station.

Furthermore, in the case where the HAPS communicates directly with terrestrial users, the HAPS knows information about locations, traffic volume, channel states, etc. of cells covered by its respective beams, which the receiving unit 210 of the electronic device 200 can directly obtain from the HAPS internally. The transmitting unit 230 may notify the control unit 220 of configuration information on the HAPS to implement a corresponding configuration by the control unit 220.

Alternatively, the electronic device 200 may be a terrestrial base station. In this case, the receiving unit 210 may obtain traffic load information of a cell covered by the terrestrial base station and receive traffic load information of a cell covered by the HAPS from the HAPS. The transmitting unit 230 may notify at least one of the HAPS and the terrestrial base station of configuration information. Similar to the case of the HAPS as the electronic device 200, since there is currently no communication interface between the HAPS and the terrestrial base station, it is also necessary to set a communication interface between the HAPS and the terrestrial base station for information interaction in the case of the terrestrial base station as the electronic device 200. According to an example of the present disclosure, the HAPS may be used as one base station, so that information interaction between the HAPS and the terrestrial base station may be performed using an interface between the base station and the base station. According to another example of the present disclosure, the terrestrial base station may be used as one child node of the HAPS, so that information interaction between the HAPS and the terrestrial base station may be performed using a backhaul interface.

Optionally, in the case where the electronic device 200 is a terrestrial base station, the HAPS may transmit to the terrestrial base station only information about a specific cell overlapping with the cell covered by the terrestrial base station among cells covered by the HAPS in the high-altitude platform station-terrestrial communication system, and configuration information of non-overlapping cells is decided by the HAPS itself. Thus, information that needs to be exchanged can be further reduced, reducing algorithm complexity.

Alternatively, according to another embodiment of the present disclosure, the electronic device 200 may be one of a CPE and a terrestrial base station, so that in this embodiment, it is sufficient to perform information interaction between the CPE and the terrestrial base station. For example, the electronic device 200 may be a CPE connected to an HAPS. In this case, the receiving unit 210 may obtain traffic load information on at least one of a cell covered by the HAPS to which the CPE is connected and a cell covered by the CPE, and receive traffic load information of a cell covered by the terrestrial base station from the terrestrial base station. The transmitting unit 230 may notify at least one of the HAPS connected to the CPE and the terrestrial base station of the configuration information.

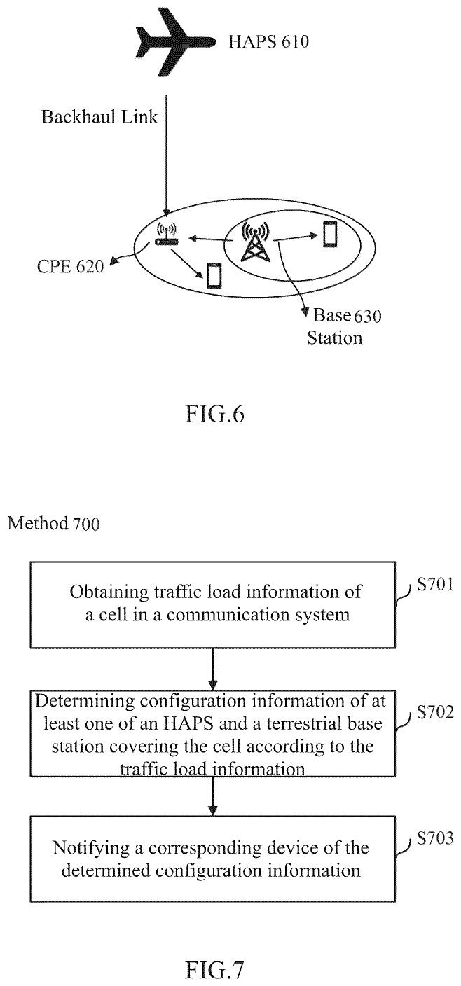

FIG. 6 is a schematic diagram illustrating an example case where the electronic device 200 is a CPE. As shown in FIG. 6, since there is currently no communication interface between the CPE 620 and the terrestrial base station 630, a communication interface between the CPE 620 and the terrestrial base station 630 may be provided for information interaction. According to an example of the present disclosure, the CPE 620 may be used as a base station, such that information interaction between the CPE 620 and the terrestrial base station may be performed using an interface between the base station and the base station. For example, the information interaction between the CPE and the terrestrial base station may be performed using an X2 interface in the LTE system, or an Xn interface in the 5G NR system.

According to another example of the present disclosure, the CPE 620 may be used as a child node of the terrestrial base station 630. A backhaul interface may thus be used for information interaction between the CPE 620 and the terrestrial base station 630. It should be noted that where CPE 620 is also used as a child node of HAPS 610 connected to the CPE, CPE 620 has 2 parent nodes, i.e., the HAPS 610 and the base station 630. At this time, one of the two parent nodes may be selected as the central control node, or both the two parent nodes may be selected as the central control nodes

Alternatively, the electronic device 200 may be a terrestrial base station. In this case, the receiving unit 210 may obtain traffic load information of a cell covered by the terrestrial base station and receive, from a CPE corresponding to the terrestrial base station, traffic load information of a cell covered by the CPE. The transmitting unit 230 may notify at least one of the CPE corresponding to the terrestrial base station and the terrestrial base station of the configuration information. Similar to the case of the CPE as the electronic device 200, since there is currently no communication interface between the CPE and the terrestrial base station, it is also necessary to set a communication interface between the CPE and the terrestrial base station for information interaction in the case of the terrestrial base station as the electronic device 200. According to an example of the present disclosure, the CPE may be used as one base station, so that information interaction between the CPE and the terrestrial base station may be performed using an interface between the base station and the base station. According to another example of the present disclosure, the terrestrial base station may be used as a parent node of the CPE so that information interaction between the CPE and the terrestrial base station may be performed using a backhaul interface.

The determination of configuration information of at least one of the HAPS and the terrestrial base station by the electronic device based on traffic load information of a cell in the communication system obtained by the receiving unit is described above in connection with FIGS. 2-6. Alternatively, at least one of the HAPS, the CPE connected to the HAPS, and the terrestrial base station may also determine the configuration information based on an interference situation without requiring the receiving unit to obtain the traffic load information.

According to an example of the present disclosure, service priorities of the terrestrial base station and the HAPS (or the CPE connected to the HAPS) may be predefined. Moreover, the configuration information may be determined according to interference between the terrestrial base station and the HAPS (or the CPE connected to the HAPS) in an area covered in overlap by the terrestrial base station and the HAPS (or the CPE connected to the HAPS).

For example, the HAPS (or the CPE connected to the HAPS) has a higher service priority, while the terrestrial base station has a lower service priority. In an area covered in overlap by the terrestrial base station and the HAPS (or the CPE connected to the HAPS), when the terrestrial base station detects interference from the HAPS (or the CPE connected to the HAPS) that exceeds a predetermined threshold, the terrestrial base station may self-determine its configuration information as an idle or a dormant state, to transition to a corresponding state and stop serving the overlapping coverage area.

As another example, the HAPS (or the CPE connected to the HAPS) has a lower service priority while the terrestrial base station has a higher service priority. In an area covered in overlap by the terrestrial base station and the HAPS (or the CPE connected to the HAPS), when the HAPS (or the CPE connected to the HAPS) detects interference from the terrestrial base station that exceeds a predetermined threshold, the HAPS (or the CPE connected to the HAPS) may determine its configuration information to stop serving the overlapping coverage area.

In addition, interference between the terrestrial base station and the HAPS (or the CPE connected to the HAPS) may also be measured by the UE, and the interference measurement may be sent to at least one of the terrestrial base station and the HAPS (or the CPE connected to the HAPS). At least one of the terrestrial base station and the HAPS (or the CPE connected to the HAPS) may determine its configuration information according to the received interference measurement.

An information transmission method according to an embodiment of the present disclosure will be described below with reference to FIG. 7. FIG. 7 is a flowchart of an information transmission method 700 according to an embodiment of the present disclosure. Since steps of the information transmission method 700 correspond to the operations of the electronic device 200 described above with reference to the figures, a detailed description of the same content is omitted herein for simplicity.

As shown in FIG. 7, in step S701, traffic load information of a cell in a communication system is obtained. According to an example of the present disclosure, the traffic load information may indicate one or more of a number of activated terminals in the cell, a throughput requirement of the cell, or a buffer status. Furthermore, according to another example of the present disclosure, the traffic load information of the cell in the communication system may be dynamically or semi-statically obtained as needed in step S701. For example, the traffic load information may be traffic load information at the current time. As another example, the traffic load information may be statistical information for a predetermined period of time in the past. In addition, the traffic load information may also indicate a predicted traffic load for a predetermined period of time in the future.

In step S702, configuration information of at least one of a high-altitude platform station (HAPS) and a terrestrial base station covering the cell may be determined according to the traffic load information. Then, the determined configuration information is notified to the corresponding device in step S703.

According to an example of the present disclosure, the configuration information may indicate an operating state of the device. For example, the operating state of the terrestrial base station may include an active state, an idle state, and the like. The configuration information of the HAPS may include information such as beams, time-frequency resources, and the like used when the HAPS is used for transmission to a specific cell. In addition, in the case where the HAPS provides services to users via a CPE, the configuration information of the HAPS may also indicate an operating state of the CPE connected to the HAPS. For example, the operating state of the CPE may be an active state, an idle state, or the like. In addition, in order to further reduce interference and save power consumption, the CPE and the terrestrial base station may also be set with a dormant state, an off state, and the like, where the dormant state may be further divided into a full dormant state, a semi-dormant state, and the like, depending on how many functions need to be shutdown. Furthermore, the configuration information may be configuration information on one or more bands.

According to another example of the present disclosure, the method 700 may comprise obtaining deployment information of the high-altitude platform station-terrestrial communication system, and in step S702, the configuration information of at least one of the high-altitude platform station (HAPS) and the terrestrial base station may be determined in combination with the received traffic load information and the deployment information. For example, the deployment information may include coverage information indicating the presence of one or both of an HAPS (or a CPE connected to the HAPS) and a terrestrial base station within the range of the cell. In this case, the coverage information of the cell in the high-altitude platform station-terrestrial communication system may also be determined in step S702; and the configuration information of at least one of the high-altitude platform station (HAPS) and the terrestrial base station covering the cell is also determined based on the coverage information.

A cell being covered by one of the HAPS and the terrestrial base station may refer to that the entire area of the cell or an area satisfying a predetermined condition (e.g., an area reaching a predetermined area) is covered by one of the HAPS and the terrestrial base station. Furthermore, a cell being covered by both the HAPS and the terrestrial base station may refer to that the entire area or an area satisfying a predetermined condition (e.g., an area reaching a predetermined area) of the cell is covered by both the HAPS and the terrestrial base station.

Furthermore, according to another example of the present disclosure, the method 700 may further include obtaining channel state information of the cell in the communication system, and in step S702, the configuration information of at least one of the HAPS and the terrestrial base station covering the cell may be determined in combination with the channel state information and the traffic load information. For example, for a cell covered by a CPE, the channel state information of the cell may be channel state information between the CPE to which the cell corresponds and a terminal device connected to the CPE. In addition, the channel state information may also include channel state information between a corresponding HAPS beam of the cell and the CPE covering the cell. For a cell covered by a terrestrial base station, the channel state information of the cell may be channel state information between the terrestrial base station to which the cell corresponds and a terminal device connected to the terrestrial base station.

In the electronic device according to the embodiment of the present disclosure, the control unit may determine configuration information of at least one of the high-altitude platform station (HAPS) and the terrestrial base station in the communication system according to traffic load information of the cell, so as to improve at least one of spectral efficiency (SE) and energy efficiency (EE) of the HAPS terrestrial system. By comprehensively considering traffic loads of cells covered by the HAPS and the terrestrial base stations in the high-altitude platform station-terrestrial communication system, uniform coordination and configuration of the HAPS and the terrestrial base stations is achieved, resulting in better system performance.

### <Hardware Structure>

In addition, block diagrams used in the description of the above embodiments illustrate blocks in units of functions. These functional blocks (structural blocks) may be implemented in arbitrary combination of hardware and/or software. Furthermore, means for implementing respective functional blocks is not particularly limited. That is, the respective functional blocks may be implemented by one apparatus that is physically and/or logically jointed; or more than two apparatuses that are physically and/or logically separated may be directly and/or indirectly connected (e.g. wired and/or wirelessly), and the respective functional blocks may be implemented by these apparatuses.

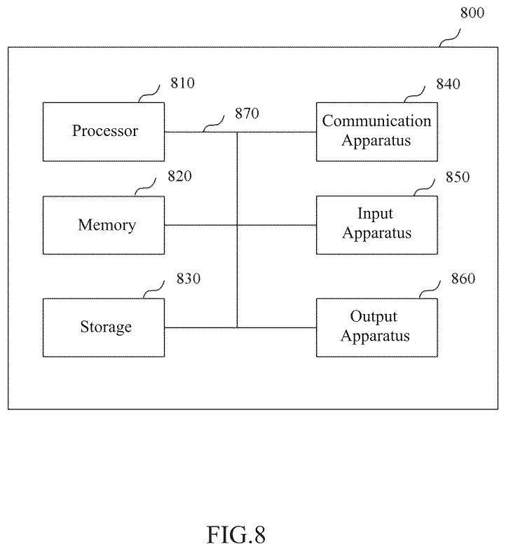

For example, the electronic device in an embodiment of the present disclosure may function as a computer that executes the processes of the information transmission method of the present disclosure. FIG. 8 is a schematic diagram of a hardware structure of an involved device 800 (the electronic device) according to an embodiment of the present disclosure. The above device 800 (the first network element) may be constituted as a computer apparatus that physically comprises a processor 810, a memory 820, a storage 830, a communication apparatus 840, an input apparatus 850, an output apparatus 860, a bus 870 and the like

In addition, in the following description, terms such as “apparatus” may be replaced with circuits, devices, units, and the like. The hardware structure of the electronic device may include one or more of the respective apparatuses shown in the figure, or may not include a part of the apparatuses.

For example, only one processor 810 is illustrated, but there may be multiple processors. Furthermore, processes may be performed by one processor, or processes may be performed by more than one processor simultaneously, sequentially, or with other methods. In addition, the processor 810 may be installed by more than one chip.

Various functions of the device 800 may be implemented, for example, by reading specified software (program) on hardware such as the processor 810 and the memory 820, so that the processor 810 performs computations, controls communication performed by the communication apparatus 840, and controls reading and/or writing of data in the memory 820 and the storage 830.

The processor 810, for example, operates an operating system to control the entire computer. The processor 810 may be constituted by a Central Processing Unit (CPU), which includes interfaces with peripheral apparatuses, a control apparatus, a computing apparatus, a register and the like. For example, the control unit described above may be implemented by the processor 810.

In addition, the processor 810 reads programs (program codes), software modules, data and the like from the storage 830 and/or the communication apparatus 840 to the memory 820, and execute various processes according to them. As for the program, a program causing computers to execute at least a part of the operations described in the above embodiments may be employed. For example, the processing unit of the first network element may be implemented by a control program stored in the memory 820 and operated by the processor 810, and other functional blocks may also be implemented similarly.

The memory 820 is a computer-readable recording medium, and may be constituted, for example, by at least one of a Read Only Memory (ROM), an Erasable Programmable ROM (EPROM), an Electrically EPROM (EEPROM), a Random Access Memory (RAM) and other appropriate storage media. The memory 820 may also be referred to as a register, a cache, a main memory (a main storage apparatus) and the like. The memory 820 may store executable programs (program codes), software modules and the like for implementing a method involved in an embodiment of the present disclosure.

The storage 830 is a computer-readable recording medium, and may be constituted, for example, by at least one of a flexible disk, a Floppy® disk, a magneto-optical disk (e.g., a Compact Disc ROM (CD-ROM) and the like), a digital versatile disk, a Blu-ray® disk, a removable disk, a hard driver, a smart card, a flash memory device (e.g., a card, a stick and a key driver), a magnetic stripe, a database, a server, and other appropriate storage media. The storage 830 may also be referred to as an auxiliary storage apparatus.

The communication apparatus 840 is a hardware (transceiver apparatus) performing communication between computers via a wired and/or wireless network, and is also referred to as a network device, a network controller, a network card, a communication module and the like, for example. The communication apparatus 840 may include a high-frequency switch, a duplexer, a filter, a frequency synthesizer and the like to implement, for example, Frequency Division Duplex (FDD) and/or Time Division Duplex (TDD). For example, the transmitting unit, the receiving unit and the like described above may be implemented by the communication apparatus 840.

The input apparatus 850 is an input device (e.g., a keyboard, a mouse, a microphone, a switch, a button, a sensor and the like) that receives input from the outside. The output apparatus 860 is an output device (e.g., a display, a speaker, a Light Emitting Diode (LED) light and the like) that performs outputting to the outside. In addition, the input apparatus 850 and the output apparatus 860 may also be an integrated structure (e.g., a touch screen).

Furthermore, the respective apparatuses such as the processor 810 and the memory 820 are connected by the bus 870 that communicates information. The bus 870 may be constituted by a single bus or by different buses between the apparatuses.

Furthermore, the electronic device may comprise hardware such as a microprocessor, a Digital Signal Processor (DSP), an Application Specified Integrated Circuit (ASIC), a Programmable Logic Device (PLD), a Field Programmable Gate Array (FPGA), etc., and the hardware may be used to implement a part of or all of the respective functional blocks. For example, the processor 810 may be installed by at least one of these hardware.

### (Variations)

In addition, terms illustrated in the present specification and/or terms required for understanding of the present specification may be substituted with terms having the same or similar meaning. For example, a channel and/or a symbol may also be a signal (signaling). Furthermore, the signal may be a message. A reference signal may be abbreviated as an “RS”, and may also be referred to as a pilot, a pilot signal and so on, depending on the standard applied. Furthermore, a component carrier (CC) may also be referred to as a cell, a frequency carrier, a carrier frequency, and the like.

Furthermore, information, parameters and so on described in this specification may be represented in absolute values or in relative values with respect to specified values, or may be represented by other corresponding information. For example, radio resources may be indicated by specified indexes. Furthermore, formulas and the like using these parameters may be different from those explicitly disclosed in this specification.

Names used for parameters and the like in this specification are not limited in any respect. For example, since various channels (Physical Uplink Control Channels (PUCCHs), Physical Downlink Control Channels (PDCCHs), etc.) and information elements may be identified by any suitable names, the various names assigned to these various channels and information elements are not limitative in any respect.

Information, signals and the like described in this specification may be represented by using any of a variety of different technologies. For example, data, instructions, commands, information, signals, bits, symbols, chips, etc. possibly referenced throughout the above description may be represented by voltages, currents, electromagnetic waves, magnetic fields or particles, optical fields or photons, or any combination thereof.

In addition, information, signals and the like may be output from higher layers to lower layers and/or from lower layers to higher layers. Information, signals and the like may be input or output via a plurality of network nodes.

Information, signals and the like that are input or output may be stored in a specific location (for example, in a memory), or may be managed through a management table. Information, signals and the like that are input or output may be overwritten, updated or appended. Information, signals and the like that are output may be deleted. Information, signals and the like that are input may be transmitted to other apparatuses.

Reporting of information is by no means limited to the manners/embodiments described in this specification, and may be implemented by other methods as well. For example, reporting of information may be implemented by using physical layer signaling (for example, Downlink Control Information (DCI), Uplink Control Information (UCI)), higher layer signaling (for example, Radio Resource Control (RRC) signaling, broadcast information (Master Information Block (MIB), System Information Block (SIB), etc.), Medium Access Control (MAC) signaling), other signals or combinations thereof.

In addition, physical layer signaling may also be referred to as L1/L2 (Layer 1/Layer 2) control information (L1/L2 control signal), L1 control information (L1 control signal) and the like. Furthermore, RRC signaling may also be referred to as RRC messages, for example, RRC connection setup messages, RRC connection reconfiguration messages, and so on. Furthermore, MAC signaling may be reported by using, for example, MAC Control Elements (MAC CEs).

Furthermore, notification of prescribed information (for example, notification of “being X”) is not limited to being performed explicitly, and may be performed implicitly (for example, by not performing notification of the prescribed information or by notification of other information). Decision may be performed by a value (0 or 1) represented by 1 bit, or by a true or false value (Boolean value) represented by TRUE or FALSE, or by a numerical comparison (e.g., comparison with a prescribed value).

Software, whether referred to as “software”, “firmware”, “middleware”, “microcode” or “hardware description language”, or called by other names, should be interpreted broadly to mean instructions, instruction sets, code, code segments, program codes, programs, subprograms, software modules, applications, software applications, software packages, routines, subroutines, objects, executable files, execution threads, procedures, functions and so on.

In addition, software, commands, information, etc. may be transmitted and received via a transport medium. For example, when software is transmitted from web pages, servers or other remote sources using wired technologies (coaxial cables, fibers, twisted pairs, Digital Subscriber Lines (DSLs), etc.) and/or wireless technologies (infrared ray, microwave, etc.), these wired technologies and/or wireless technologies are included in the definition of the transport medium.

The terms “system” and “network” used in this specification may be used interchangeably.

In this specification, terms like “Base Station (BS)”, “wireless base station”, “eNB”, “gNB”, “cell”, “sector”, “cell group”, “carrier” and “component carrier” may be used interchangeably. A base station is sometimes referred to as terms such as a fixed station, a NodeB, an eNodeB (eNB), an access point, a transmitting point, a receiving point, a femto cell, a small cell and the like.

A base station is capable of accommodating one or more (for example, three) cells (also referred to as sectors). In the case where the base station accommodates a plurality of cells, the entire coverage area of the base station may be divided into a plurality of smaller areas, and each smaller area may provide communication services by using a base station sub-system (for example, a small base station for indoor use (a Remote Radio Head (RRH)). Terms like “cell” and “sector” refer to a part of or an entirety of the coverage area of a base station and/or a sub-system of the base station that provides communication services in this coverage.

In this specification, terms such as “Mobile Station (MS)”, “user terminal”, “User Equipment (UE)”, and “terminal” may be used interchangeably. The mobile station is sometimes referred by those skilled in the art as a user station, a mobile unit, a user unit, a wireless unit, a remote unit, a mobile device, a wireless device, a wireless communication device, a remote device, a mobile user station, an access terminal, a mobile terminal, a wireless terminal, a remote terminal, a handset, a user agent, a mobile client, a client, or some other appropriate terms.

Furthermore, a wireless base station in this specification may also be replaced with a user terminal. For example, for a structure in which communication between a wireless base station and a user terminal is replaced with communication between a of plurality user (Device-to-Device, D2D), the respective terminals manners/embodiments of the present disclosure may also be applied. In this case, functions provided by the electronic device described above may be regarded as functions provided by a user terminal. Furthermore, the words “uplink” and “downlink” may also be replaced with “side”. For example, an uplink channel may be replaced with a side channel.

Also, a user terminal in this specification may be replaced with a wireless base station. In this case, functions provided by the above user terminal may be regarded as functions provided by a first communication device or a second communication device.

In this specification, specific actions configured to be performed by the base station sometimes may be performed by its upper nodes in certain cases. Obviously, in a network composed of one or more network nodes having base stations, various actions performed for communication with terminals may be performed by the base stations, one or more network nodes other than the base stations (for example, Mobility Management Entities (MMEs), Serving-Gateways (S-GWs), etc., may be considered, but not limited thereto)), or combinations thereof.

The respective manners/embodiments described in this specification may be used individually or in combinations, and may also be switched to use during execution. In addition, orders of processes, sequences, flow charts and so on of the respective manners/embodiments described in this specification may be re-ordered as long as there is no inconsistency. For example, although various methods have been described in this specification with various units of steps in exemplary orders, the specific orders as described are by no means limitative.

The manners/embodiments described in this specification may be applied to systems that utilize Long Term Evolution (LTE), Advanced Long Term Evolution (LTE-A, LTE-Advanced), Beyond Long Term Evolution (LTE-B, LTE-Beyond), the super 3rd generation mobile communication system (SUPER 3G), Advanced International Mobile Telecommunications (IMT-Advanced), the 4th generation mobile communication system (4G), the 5th generation mobile communication system (5G), Future Radio Access (FRA), New Radio Access Technology (New-RAT), New Radio (NR), New radio access (NX), Future generation radio access (FX), Global System for Mobile communications (GSM®), Code Division Multiple Access 3000 (CDMA 3000), Ultra Mobile Broadband (UMB), IEEE 920.11 (Wi-Fi®), IEEE 920.16 (WiMAX®), IEEE 920.20, Ultra-Wide Band (UWB), Bluetooth® and other appropriate wireless communication methods, and/or next-generation systems that are enhanced based on them.

Terms such as “based on” as used in this specification do not mean “based on only”, unless otherwise specified in other paragraphs. In other words, terms such as “based on” mean both “based on only” and “at least based on.”

Any reference to units with designations such as “first”, “second” and so on as used in this specification does not generally limit the quantity or order of these units. These designations may be used in this specification as a convenient method for distinguishing between two or more units. Therefore, reference to a first unit and a second unit does not imply that only two units may be employed, or that the first unit must precedes the second unit in several ways.

Terms such as “deciding (determining)” as used in this specification may encompass a wide variety of actions. The “deciding (determining)” may regard, for example, calculating, computing, processing, deriving, investigating, looking up (e.g., looking up in a table, a database or other data structures), ascertaining, etc. as performing the “deciding (determining)”. In addition, the “deciding (determining)” may also regard receiving (e.g., receiving information), transmitting (e.g., transmitting information), inputting, outputting, accessing (e.g., accessing data in a memory), etc. as performing the “deciding (determining)”. In addition, the “deciding (determining)” may further regard resolving, selecting, choosing, establishing, comparing, etc. as performing the “deciding (determining)”. That is, the “deciding (determining)” may regard certain actions as performing the “deciding (determining)”.

As used herein, terms such as “connected”, “coupled”, or any variation thereof mean any direct or indirect connection or coupling between two or more units, and may include the presence of one or more intermediate units between two units that are “connected” or “coupled” to each other. Coupling or connection between the units may be physical, logical or a combination thereof. For example, “connection” may be replaced with “access.” As used in this specification, two units may be considered as being “connected” or “coupled” to each other by using one or more electrical wires, cables and/or printed electrical connections, and, as a number of non-limiting and non-inclusive examples, by using electromagnetic energy having wavelengths in the radio frequency region, microwave region and/or optical (both visible and invisible) region.

When terms such as “including”, “comprising” and variations thereof are used in this specification or the claims, these terms, similar to the term “having”, are also intended to be inclusive. Furthermore, the term “or” as used in this specification or the claims is not an exclusive or.

Although the present disclosure has been described above in detail, it should be obvious to a person skilled in the art that the present disclosure is by no means limited to the embodiments described in this specification. The present disclosure may be implemented with various modifications and alterations without departing from the spirit and scope of the present disclosure defined by the recitations of the claims. Consequently, the description in this specification is for the purpose of illustration, and does not have any limitative meaning to the present disclosure.

1. An electronic device in a high-altitude platform station-terrestrial communication system, comprising:
a receiving unit configured to obtain traffic load information of a cell in the communication system;
a control unit configured to determine configuration information of at least one of a high-altitude platform station (HAPS) and a terrestrial base station covering the cell according to the traffic load information, and
a transmitting unit configured to notify of the configuration information.

2. The electronic device of claim 1, wherein
the receiving unit is further configured to obtain channel state information of the cell in the communication system; and
the control unit is further configured to determine the configuration information of the at least one of the HAPS and the terrestrial base station covering the cell according to the channel state information.

3. The electronic device of claim 1, wherein
the HAPS in the high-altitude platform station-terrestrial communication system is connected to a cloud;
the terrestrial base station in the high-altitude platform station-terrestrial communication system is connected to the cloud;
the electronic device is disposed in the cloud;
the receiving unit receives the traffic load information from cells of the HAPS and the terrestrial base station in the high-altitude platform station-terrestrial communication system; and
the transmitting unit notifies at least one of the HAPS and the terrestrial base station in the high-altitude platform station-terrestrial communication system of the configuration information.

4. The electronic device of claim 1, wherein
the electronic device is the HAPS in the high-altitude platform station-terrestrial communication system;
the receiving unit obtains traffic load information of a cell covered by the HAPS and receives, from a terrestrial base station within a coverage range of the HAPS, traffic load information of a cell covered by the terrestrial base station; and
the transmitting unit notifies at least one of the HAPS and the terrestrial base station within the coverage range of the HAPS of the configuration information.

5. The electronic device of claim 1, wherein
the electronic device is the terrestrial base station;
the receiving unit obtains traffic load information of a cell covered by the terrestrial base station and receives, from an HAPS corresponding to the terrestrial base station, traffic load information of a cell covered by the HAPS; and
the transmitting unit notifies at least one of the terrestrial base station and the HAPS corresponding to the terrestrial base station of the configuration information.

6. The electronic device of claim 4, wherein
the HAPS and the terrestrial base stations communicate over an interface between base stations or a backhaul interface.

7. The electronic device of claim 4, wherein
the HAPS is used as a centralized unit or a donor-distributed unit of integrated access backhaul, and
a customer premises equipment (CPE) connected to the HAPS is used as a distributed unit of the integrated access backhaul or a mobile terminal.

8. The electronic device of claim 1, wherein
the electronic device is a customer premises equipment (CPE) connected to the HAPS in the high-altitude platform station-terrestrial communication system;
the receiving unit obtains traffic load information on at least one of a cell covered by the HAPS to which the CPE is connected and a cell covered by the CPE, and receives, from a terrestrial base station within a coverage range of the CPE, traffic load information of a cell covered by the terrestrial base station; and
the transmitting unit notifies at least one of the CPE and the terrestrial base station within the coverage range of the CPE of the configuration information.

9. The electronic device of claim 1, wherein
the electronic device is the terrestrial base station;
the receiving unit obtains traffic load information of a cell covered by the terrestrial base station and receives, from a customer premises equipment (CPE) corresponding to the terrestrial base station, traffic load information of a cell covered by the CPE; and
the transmitting unit notifies at least one of the CPE corresponding to the terrestrial base station and the terrestrial base station of the configuration information.

10. The electronic device of claim 8, wherein
the CPE and the terrestrial base station communicate over an interface between base stations or a backhaul interface.
